(19) United States
(12) Patent Application Publication
(10) Pub. No.: US 2007/0137779 A1
(43) Pub. Date: Jun. 21, 2007

(54) Process for laser welding

(76) Inventors: Hiroshi Mori, Tokyo (JP); Mitsunobu Nakatani, Tochigi (JP); Hiroyuki Sumi, Tochigi (JP); Katsuhiko Nakajima, Aichi (JP); Hideo Nakamura, Aichi (JP); Toshio Watanabe, Aichi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/581,246

(22) Filed: Oct. 16, 2006

Related U.S. Application Data
(60) Provisional application No. 60/728,246, filed on Oct. 19, 2005.

(51) Int. Cl. B32B 37/00

(52) U.S. Cl. 156/272.8

(57) ABSTRACT

A process for laser welding objects wherein a polymeric film having an absorptivity of 5 percent or less at the wavelength of the laser used is placed between the objects welded prior to welding.

### CROSS REFERENCE TO RELATED APPLICATIONS

This application claims the benefit of priority to U.S. Provisional Application No. 60/728,246, filed Oct. 19, 2005.

### FIELD OF THE INVENTION

The present invention relates to a process for laser welding polymeric objects.

### BACKGROUND OF THE INVENTION

It is often desired to produce molded polymeric parts that can be mechanically assembled into more complex parts. Traditionally, plastic parts have been assembled by gluing or bolting them together or using snap-fit connections or using chemical means such as adhesives. These methods suffer from the drawback that they can add complicated additional steps to the assembly process. Snap-fit connections are often not gas- and liquid-tight and can require complex designs. Newer techniques are vibration and ultrasonic welding, but these can also require complex part designs and welding apparatuses. Additionally, the friction from the process can generate dust that can contaminate the inside of the parts. This is a particular problem when sensitive electrical or electronic components are involved.

A more recently developed technique is laser welding. In this method, two polymeric objects to be joined have different levels of light transmission at the wavelength of the laser that is used. One object is at least partially transparent to the wavelength of the laser light (and referred to as the “relatively transparent” object), while the second part absorbs a significant portion of the incident radiation (and is referred to as the “relatively opaque” object). Each of the objects presents a faying surface and the relatively transparent object presents an impinging surface, opposite the faying surface thereof. The faying surfaces are brought into contact, thus forming a juncture. A laser beam is directed at the impinging surface of the relatively transparent object such that it passes through the first object and irradiates the faying surface of the second object, causing the first and second objects to be welded at the juncture of the faying surfaces. See generally U.S. Pat. No. 5,893,959, which is hereby incorporated by reference herein, and JP S60-214931 A and JP S62-142092 A. This process can be very clean, simple, and fast and provides very strong, easily reproducible welds and significant design flexibility.

However, at high laser output powers, it can be difficult to create welds having good strength, as some materials may begin to burn at high powers, which can lead to a reduction in weld strength. It would be desirable to obtain a method of effectively laser welding articles even when high laser output powers are used.

JP 2003-181931 A discloses a method of laser welding together two objects that are transparent to light at the wavelength of the laser used for welding wherein a very thin film that absorbs infrared radiation at the wavelength used for welding is placed between the two objects at the points at which the objects are to be welded together. The film absorbs the laser radiation and melts, thereby serving as an adhesive to bond together the two objects.

### SUMMARY OF THE INVENTION

There is disclosed and claimed herein a process for welding a first polymeric object to a second polymeric object using laser radiation, wherein the first polymeric object is relatively transparent to the laser radiation and the second object is relatively opaque to the laser radiation, the first and the second objects each presenting a faying surface, said first object presenting an impinging surface, opposite said faying surface thereof, said process comprising the steps of (1) bringing the faying surface of the first object into physical contact with one side of a polymeric film and the faying surface of the second object into physical contact with the other side of the polymeric film to form a juncture between the first object, second object, and polymeric film, and (2) irradiating said first and second objects and polymeric film with said laser radiation such that said laser radiation impinges the impinging surface, passes through said first object and polymeric film and irradiates said faying surface of said second object, causing said first and second objects to be welded at the juncture of the faying surfaces, wherein the polymeric film has an absorptivity of 5 percent or less at the wavelength of the laser radiation.

### BRIEF DESCRIPTION OF THE DRAWINGS

FIG. 1(a-1) is a top view of a relatively transparent object used in the process of laser welding.

FIG. 1(a-2) is a view of the polymeric film used in the process of the present invention.

FIG. 1(a-3) is a top view of a relatively opaque object used in the process of laser welding

FIG. 1(b) is a top view of a relatively transparent object and a relatively opaque object in physical contact with a polymeric film.

FIG. 2 is a top view of two test pieces being laser welded.

FIG. 3(a) is a side view of two test pieces being laser welded.

FIG. 3(b) is a view of a laser welded article prepared by the process of the present invention.

FIG. 4 is a graph showing weld strength as a function of laser power of an article formed by laser welding according to the present invention and a comparative example.

### DETAILED DESCRIPTION OF THE INVENTION

The present invention relates to a process of laser welding together a relatively transparent object and a relatively opaque object wherein a polymeric film is placed between the two objects at the areas at which the articles are to be welded together (i.e., their faying surfaces). The presence of the film reduces the likelihood that burning of the objects will occur when they are welded at high laser powers. This can lead to welds having improved strengths when high powers are used, thus increasing the flexibility of the welding process.

The polymeric film used in the present invention has an absorptivity at the wavelength of the laser used for welding of less than or equal to about 5 percent, or preferably less than or equal to about 3 percent or more preferably less than or equal to about 1 percent. Percent absorptivity at a given wavelength can be calculated by subtracting the percent transmittance and percent reflectance of the film at that wavelength from 100%. Percent transmittance and percent reflectance can be measured using any suitable method, including commercially available spectrophotometers. In the event that different apparatuses give different results for the percent absorptivity of the film, a Shimadzu Corp. UV3100 UV-VIS-NIR spectrophotometer should be used for the measurements.

The polymeric film preferably has a thickness of less than about 100 micrometers, or more preferably about 1 to about 50 micrometers, still more preferably about 1 to about 30 micrometers, even more preferably about 3 to about 20 micrometers, or yet more preferably about 5 to about 18 micrometers. If the film is too thin, it can be difficult to handle. If it is too thick, the presence of the film could in some cases decrease the effectiveness of laser welding if the film absorbed too much of the laser radiation. It is preferred that the polymer film be made from a material having a thermal conductivity that is less than that of the material of the relatively transparent and/or relatively opaque object, as this can lead to greater weld strengths.

The polymeric film is preferably made from a thermoplastic polymer. Examples of suitable thermoplastic polymers include, but are not limited to, polyesters (such as poly(ethylene terephthalate) (PET), poly(trimethylene terephthalate) (PTT), poly(butylene terephthalate) (PBT), poly(ethylene naphthalate) (PEN), and poly(1,4-cyclohexanedimethanol terephthalate) (PCT)); polycarbonates; polyamides, polystyrenes; and poly(meth)acrylates (such as poly(methyl methacrylate)).

The film may be produced by any suitable film-forming process such as a single-axis extension method, a double-axis extension method, an inflation molding method, a sheet casting method, a pressing method, and the like.

The relatively opaque object and relatively transparent object may comprising one or more polymer resins. The one or more polymer resins preferably comprise thermoplastic polymers. The polymer resins may comprise polymers including, but not limited to, polyesters (including aromatic, semiaromatic, and aliphatic polyesters); liquid crystalline polymers (including liquid crystalline polyesters); polyamides (including aromatic, semiaromatic, and aliphatic polyamides); polycarbonates; polyoxymethylenes; polyimides; polybenzimidazoles; polyketones; polyether ether ketones; polyether ketones; polyether sulfones; poly(phenylene oxide); phenoxy resins; poly(phenylene sulfide); polystyrenes; polyolefins (such as polyethylene, polypropylene, ethylene/propylene copolymer, ethylene/1-butene copolymer, ethylene/propylene/non-conjugated diene copolymer, ethylene/ethyl acrylate copolymer, ethylene/glycidyl methacrylate copolymer, ethylene/vinyl acetate/glycidyl methacrylate copolymer, ethylene/propylene copolymer grafted with maleic acid and/or maleic anhydride, etc.); ABS; elastomers (such as polyester polyether elastomer, polyester polyester elastomer, etc.); and the like.

The polymer resins may be in the form of compositions comprising additional components such as reinforcing agents and fillers. The polymer resins are preferably in the form of compositions containing glass fibers. The compositions may optionally further contain additional components such as one or more antioxidants, pigments, dyes, heat stabilizers, UV light stabilizers, weathering stabilizers, mold release agents, lubricants, nucleating agents, plasticizers, antistatic agents, flame retardants, other polymers, and the like. The additional components will be selected according to the desired properties of the objects.

The compositions used for the relatively opaque article may optionally further contain dyes and/or pigments such as carbon black and nigrosine that aid in the absorption of laser light by the composition.

The compositions used for the relatively transparent object may have a natural color or may contain dyes that are sufficiently transparent to the wavelength of light used for laser welding. Such dyes may include, for example, anthraquinone-based dyes.

The compositions are in the form of melt-mixed blends, wherein the polymeric components are well-dispersed within each other and all of the non-polymeric ingredients are dispersed in and bound by the polymer matrix, such that the blend forms a unified whole. The blend may be obtained by combining the component materials using any melt-mixing method. The component materials may be mixed using a melt-mixer such as a single- or twin-screw extruder, blender, kneader, roller, Banbury mixer, etc. to give a resin composition. Or, part of the materials may be mixed in a melt-mixer, and the rest of the materials may then be added and further melt-mixed. The sequence of mixing in the manufacture of the compositions of the invention may be such that individual components may be melted in one shot, or the filler and/or other components may be fed from a side feeder, and the like, as will be understood by those skilled in the art.

The objects used in the laser welding process of the present invention may be formed from the polymer resins using any methods known to those skilled in the art, such as, for example, injection molding, extrusion, blow molding, injection blow molding, compression molding, foaming molding, vacuum molding, rotation molding, calendar molding, solution casting, or the like.

Preferred lasers for use in the laser welding process of the present invention are any lasers emitting light having a wavelength within the range of about 800 nm to about 1200 nm. Examples of types of preferred lasers are YAG and diode lasers. Preferred wavelengths are in the near-infrared such as 808, 940, 980 nm, etc.

The polymeric film may be placed between the faying surfaces of the relatively opaque and relatively transparent objects using any suitable method. For example, the film may be affixed either or both of the relatively opaque and relatively transparent objects using an adhesive. The film may also be adhered to the relatively opaque or relatively transparent object by overmolding. Alternatively, the polymeric film may be inserted between the relatively opaque and relatively transparent objects and the resulting laminate can be welded without any additional immobilization or the laminate may be immobilized and held firmly together by using, for example, a clamp, air pressure, or other suitable means.

During welding, the polymeric film is melted and joined to the objects being melted.

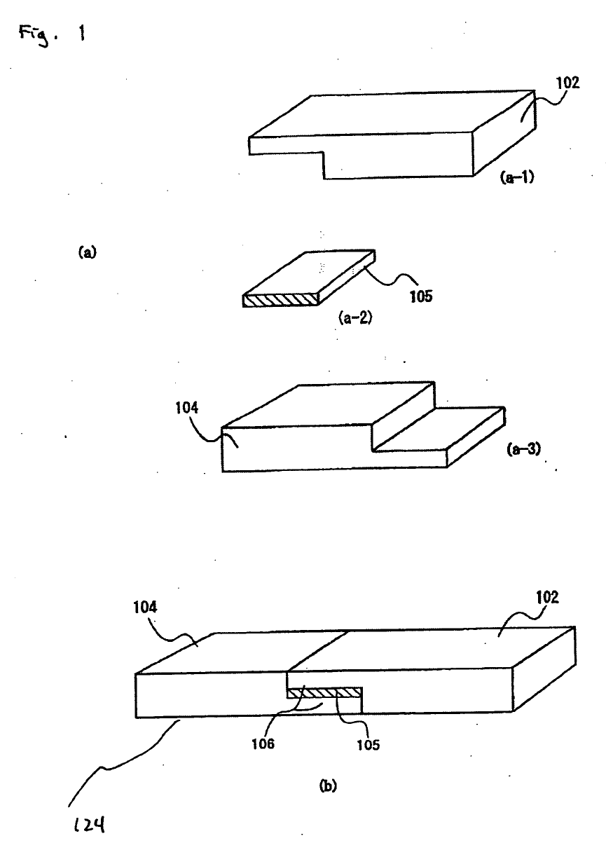

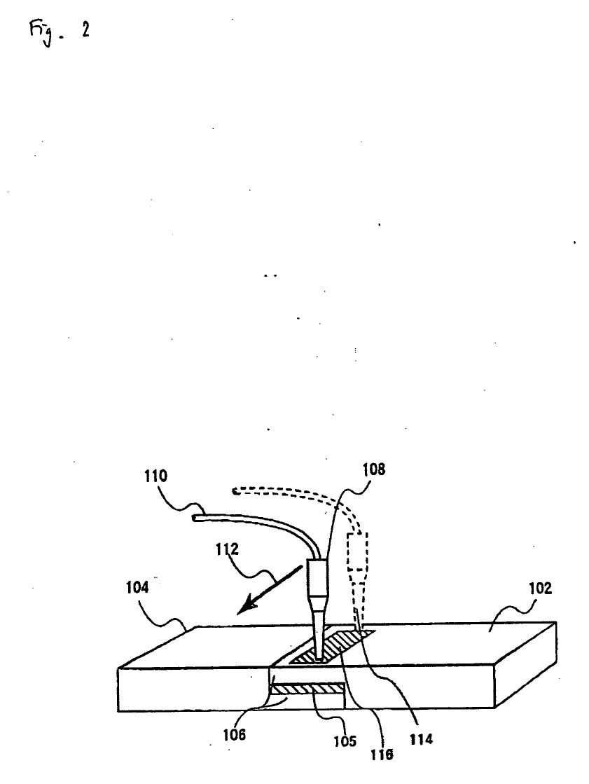

The process of laser welding is exemplified in the figures. FIG. 1(a-1) illustrates relatively transparent object 102. FIG. 1(a-2) illustrates polymeric film 105. FIG. 1(a-3) illustrates relatively opaque object 104. Referring to FIG. 1(b), relatively transparent object 102 having a half lap 106 is placed into contact with one side of polymeric film 105 and relatively opaque object 104 having a half lap 106 is placed into contact with the other side of polymeric film 105 so as to form a juncture between half laps 106 and polymeric film 105 to form a laminated structure 124. Objects 102 and 104 and the polymeric film 102 of laminated structure 124 are preferably immobilized and held firmly together by using, for example, a clamp, air pressure, or other suitable means (not shown).

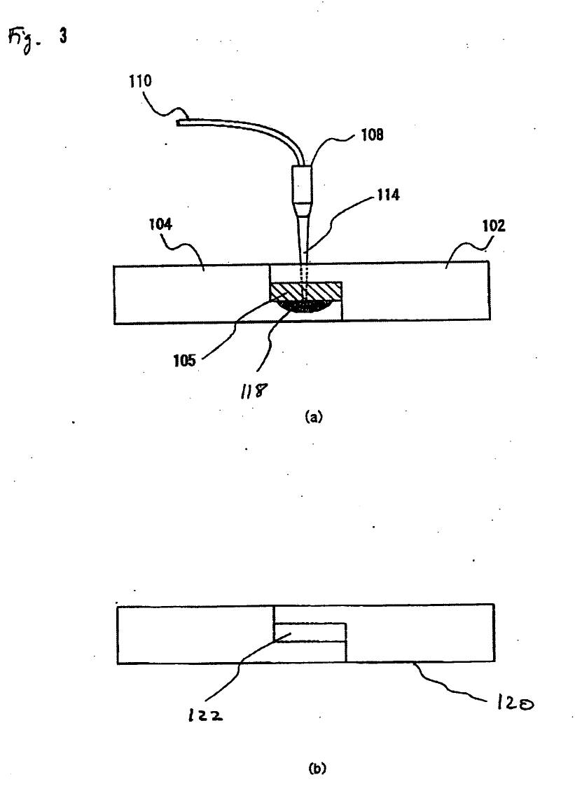

Referring to FIGS. 2 and 3(a), laser light 114 (supplied from the laser (not shown) by optical fiber 110 through laser irradiator 108) is passed across the impinging surface 116 of relatively transparent object 102 in direction 112. The light passes through relatively transparent object 102 and polymeric film 105 and irradiates the surface of half lap 106 of relatively opaque object 104, causing the polymer at the surface of object 104 to be melted at heat generation spot 118 and causing objects 102 and 104 to be welded.

FIG. 3(b) shows an article 120 laser welded at area 122.

The motion of laser irradiator 108 as it is scanned across impinging surface 116 may be controlled by the arm (not shown) of an industrial robot into which information such as the scanning path is programmed. Alternatively, the objects 102 and 104 and film 105 may be affixed to an XYZ stage and moved relative to a stationary laser irradiator. Any suitable alternative means of moving the objects to be welded and laser light relative to each other may also be used. The speed of scanning can differ depending on the materials to be welded. For example, for a polyolefin resin such as polypropylene, a scanning speed of about 200 to about 1000 cm/sec can be used. In addition, the laser power necessary to effect an effective weld can also vary according to the materials to be welded. Factors include the transmissivity of the relatively transparent object at the wavelength of the laser, the thickness of the objects at their points to be welded, the scanning speed of the laser, etc. For example, for a polyolefin resin like polypropylene a laser power of about 10 to 180 W can be used.

The process of the present invention is particularly effective in cases where the objects to be welded and welded article are susceptible to burning, as such as when lasers having high output powers are used and/or when the relatively opaque object has a particularly low transmissivity of the laser radiation.

In the process of the present invention the output power of the laser used is preferably more than about 95 W and is more preferably about 95 to about 180 W, or yet more preferably about 95 to about 130 W.

The welding path may be linear as illustrated in FIG. 1(b), or may take on a different, non-linear or partially non-linear form. The objects to be welded may take a wide variety of forms and shapes, such as discs, cylinders, hemispheres, and irregular shapes. The impinging surfaces of the objects may also have a uniform thickness along the welding path or the thickness may vary.

The objects to be welded and the polymeric film may have any suitable form at their faying surfaces, provided they can be placed into adequate physical contact with the polymeric film to allow for laser welding.

Although the thickness of the relatively transparent object at points to be laser welded is not particularly limited as long as welding is possible, the thickness of such parts at such points will preferably be about 0.1 to about 10 mm, or more preferably about 0.5 to about 5 mm. The use of objects having such thicknesses can optimize the resulting weld strength. Although the thickness of the relatively opaque object at points to be laser welded is not particularly limited as long as welding is possible, the thickness of such parts at such points will preferably be about 0.1 to about 10 mm, or more preferably about 0.5 to about 5 mm.

The present invention also includes any laser-welded article made from the process of the invention. Useful articles include articles for use in electrical and electronic applications, automotive components, office equipment parts, building materials, parts for industrial equipment such as conveyors, parts for medical devices, and parts for consumer goods such as toys and sporting goods. Examples of automotive components include engine compartment components, intake manifolds, underhood parts, radiator components, cockpit instrument panel components. Useful electrical and electronic components include sensor housings, personal computers, liquid crystal projectors, mobile computing devices, cellular telephones, and the like. Examples of office equipment parts are parts for printers, copiers, fax machines, and the like.

### EXAMPLES

### Example 1

Referring to FIG. 1(a-1), Rynite® 530 NC010, a poly(ethylene terephthalate) resin containing 30 weight percent glass fibers (supplied by E.I. du Pont de Nemours and Co., Wilmington, Del.), was injection molded into relatively transparent object 102 using a Sumitomo Heavy Machinery Industries, Ltd. SE100D injection molding machine. The resin melt temperature was 290° C. and the mold temperature was 120° C.

Referring to FIG. 1(a-3), Rynite® 530 BK503, a poly(ethylene terephthalate) resin containing 30 weight percent glass fibers and black colorant (supplied by E.I. du Pont de Nemours and Co., Wilmington, Del.), was injection molded into relatively opaque object 104 using the same method as was used for object 102.

Objects 102 and 104 had a length of 20 mm and a width of 18 mm. The thickness of objects 102 and 104 was 3 mm in its thickest portion and 1.5 mm at half lap 106.

Referring to FIG. 1(a-2), a film having a thickness of 16 micrometers, a length of 20 mm, and a width of 18 mm cut from a sheet of Diafoil R-310 16 micron 2-axis extension poly(ethylene terephthalate) film supplied by Mitsubishi Chemical Polyester Film Inc. Co. was used as polymeric film 105. The polymeric film had an absorptivity of 0% at 940 nm. The percent absorptivity was calculated by subtracting the percent transmittance and percent reflectance of the film from 100%. The transmissivity and reflectance were measured using a UV3100 UV-VIS-NIR spectrophotometer supplied by Shimadzu Corp.

Referring to FIG. 1(b), half lap 106 of object 102 and half lap 106 of object 104 were placed into contact with polymeric film 105 to form laminated structure 124. The components of laminated structure 124 were immobilized under a load of 0.6 MPa.

Referring to FIG. 2, objects 102 and 104 were welded together using a laser manufactured by Rofin-Sinar of Germany (not shown) operating at a wavelength of 940 nm and having a focusing diameter of 3 mm, a focal length of 120 mm, and a maximum power of 500 W. The laser light 114 was conducted from the laser to objects 102 and 104 and polymeric film 105 via optical fiber 110 and laser irradiator 108). The laser was scanned at a speed of 1 m/min. Samples were welded using different laser output powers. The actual laser power impinging on the surface of object 102 was measured and is herein referred to as “laser output power.”

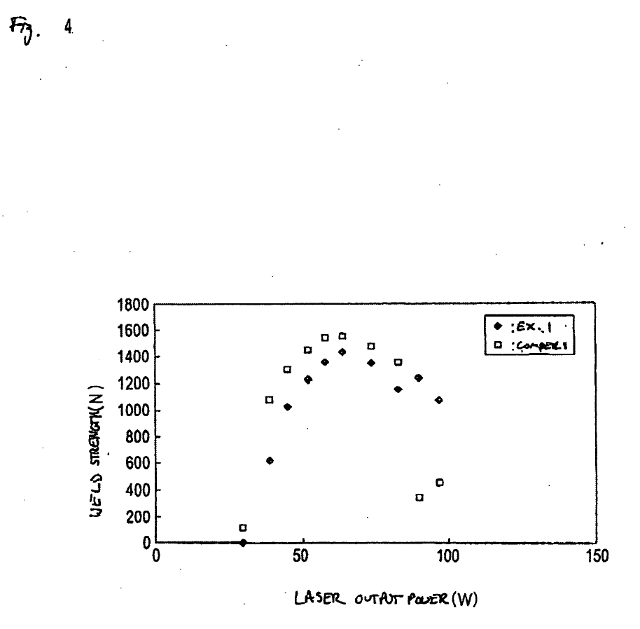

The tensile shear strength of the resulting welds (referred to herein as the weld strength) were determined by clamping the shoulders of the resulting welded articles in a tensile strength tester manufactured by Shimadzu Corp. and applying a tensile force in the longitudinal direction of the welded articles. The tester was operated at a rate of 2 mm/min. The results are shown in Table 1 and FIG. 4.

### Comparative Example 1

Comparative Example 1 was carried out using the same procedure as was used for Example 1, except that the polymeric film was not used. The results are shown in Table 1 and FIG. 4. Burning of samples occurred when welding with laser output powers of 96 and 103.

TABLE 1

| | |
|---|---|
| Laser output | Weld strength (N) |

| power | Example 1 | Comparative Ex. 1 |
|---|---|---|
| 36 | 0 | 113 |
| 45 | 603 | 1061 |
| 51 | 1009 | 1275 |
| 58 | 1201 | 1418 |
| 64 | 1328 | 1512 |
| 70 | 1405 | 1520 |
| 80 | 1324 | 1446 |
| 89 | 1130 | 1329 |
| 96 | 1211 | 338 |
| 103 | 1053 | 441 |

A comparison of Example 1 with Comparative Example 2, shows that by laminating a polymeric film between two articles to be laser welded allows the objects to be welded with a good weld strength at high laser output powers. Furthermore, the presence of the polymeric film suppresses the likelihood that the objects will burn when welded with lasers operating at high output powers.

What is claimed is:

1. A process for welding a first polymeric object to a second polymeric object using laser radiation, wherein the first polymeric object is relatively transparent to the laser radiation and the second object is relatively opaque to the laser radiation, the first and the second objects each presenting a faying surface, said first object presenting an impinging surface, opposite said faying surface thereof, said process comprising the steps of (1) bringing the faying surface of the first object into physical contact with one side of a polymeric film and the faying surface of the second object into physical contact with the other side of the polymeric film to form a juncture between the first object, second object, and polymeric film, and (2) irradiating said first and second objects and polymeric film with said laser radiation such that said laser radiation impinges the impinging surface, passes through said first object and polymeric film and irradiates said faying surface of said second object, causing said first and second objects to be welded at the juncture of the faying surfaces, wherein the polymeric film has an absorptivity of 5 percent or less at the wavelength of the laser radiation.

2. The process of claim 1, wherein the polymeric film has a thickness of less than about 100 micrometers.

3. The process of claim 1, wherein the polymeric film has a thickness of about 1 to about 50 micrometers.

4. The process of claim 1, wherein the polymeric film has a thickness of about 3 to about 20 micrometers

5. The process of claim 1, wherein the polymeric film has a thickness of about 5 to about 18 micrometers.

6. The process of claim 1, wherein the polymeric film comprises one or more of polyesters, polycarbonates, polyamides, polystyrenes, and poly(meth)acrylates.

7. The process of claim 6, wherein the polyester is one or more of poly(ethylene terephthalate) (PET), poly(trimethylene terephthalate) (PTT), poly(butylene terephthalate) (PBT), poly(ethylene naphthalate) (PEN), and poly(1,4-cyclohexanedimethanol terephthalate) (PCT).

8. Then process of claim 1, wherein the polymeric film has an absorptivity of less than or equal to about 3 percent.

9. The process of claim 1, wherein the polymeric film has an absorptivity of less than or equal to about 1 percent.

10. A laser welded article made by the process of claim 1.

11. The article of claim 10 in the form of an automotive component.
